(19) United States
(12) Patent Application Publication
(10) Pub. No.: US 2012/0325335 A1
(43) Pub. Date: Dec. 27, 2012

(54) COUPLING FOR THE RELEASABLE COUPLING OF PIPES

(75) Inventors: Erwin Ruben Schalkx, Vlaardingen (NL); Leonardus Maria Poppelier, Helvoirt (NL); Laurens Jan de Jonge, Delft (NL); Wiebrand Bernandus Adriaan Boomsma, Rotterdam (NL)

(73) Assignee: IHC HOLLAND IE B.V., SLIEDRECHT (NL)

(21) Appl. No.: 13/518,737

(22) PCT Filed: Dec. 14, 2010
(86) PCT No.: PCT/NL2010/050845

§ 371 Date: Aug. 14, 2012

Related U.S. Application Data
(60) Provisional application No. 61/289,769, filed on Dec. 23, 2009.

(30) Foreign Application Priority Data
Dec. 23, 2009 (NL) 2004010

(51) Int. Cl. F16L 21/00; F16L 55/00; F16L 9/00

(52) U.S. Cl. 137/315.01; 138/109; 285/401

(57) ABSTRACT

The invention relates to a coupling (8) for the releasable coupling of pipe parts, the coupling (8) comprising: a first pipe part (9), which on the inner circumference has two or more rows (18, 19) of lugs (13, 15); a second pipe part (10), which on the outer circumference has two or more rows (30, 31) of lugs (23, 24); wherein the lugs (13, 15, 23, 24) of each of the rows (18, 19, 30, 31) of the first pipe part (9) and of the second pipe part (10) have interspaces (12, 14, 25, 26) which are designed to allow lugs of one pipe part to pass the lugs of the other pipe part for sliding of the pipe parts (9, 10) into and out of one another in the axial direction, and wherein the pipe parts (9, 10), in the slid-together state, can be twisted in the tangential direction to make the lugs (13, 15) of the first pipe part (9) engage on the lugs (23, 24) of the second pipe part (10) for fixing of the pipe parts (9, 10) in the axial direction.

The present invention relates to a coupling for the releasable coupling of pipes or parts thereof.

When material such as silt, sand, stones, blocks and the like is planted on a water bottom and/or when bed material is removed from a water bottom, e.g. in the dredging thereof, an assembly of pipes placed one behind the other, via which the material can be transported from or to the bottom, is attached to a vessel, for example a dredging ship. To this end, the vessel is navigated to above the location at which the material must be planted or from which the material must be removed. After this, the pipes are placed one at a time one behind the other and coupled together. The material transport between the water bottom and the water surface can then be regulated via the pipe assembly. A known solution comprises the stacking of pipelines which are held together with a steel cable. A drawback of the known pipe assemblies is that the maximal combined length of the pipes is limited. In practice, lengths up to a maximum of about 500 metres are feasible. The assembly must be resistant to high loads formed principally by a combination of traction and bending moment. In place of the stacking of pipes, a coupling has been devised which makes it possible to couple the pipes in a quick and/or automatic manner.

The pipe parts can be slid one into the other, the lugs of one pipe part being able to be rotated behind the lugs of the other pipe part. Such a bayonet coupling is relatively weak, however. As the axial forces upon the pipe parts increase, the lugs of the coupling will need to be made heavier. The result of this is that the coupling becomes heavy and bulky.

The object of the present invention is to provide an improved coupling in which at least one of the said drawbacks has been overcome or, at least, lessened.

A further object of the invention is to provide a light, slender coupling which can nevertheless absorb a relatively large axial force.

It is also an object of the invention to provide a coupling with which pipes can be coupled to one another or uncoupled from one another in a relatively quick and/or simple manner.

According to a first aspect of the present invention, at least one of the objects or other objects deriving from the following description is achieved in a coupling for the releasable coupling of pipe parts, the coupling comprising:
a first pipe part, which on the outer circumference has two or more rows of lugs;
a second pipe part, which on the inner circumference has two or more rows of lugs;
   wherein the lugs of each of the rows of the first pipe part and of the second pipe part have interspaces which are designed to allow lugs of one pipe part to pass the lugs of the other pipe part for sliding of the pipe parts into and out of one another in the axial direction, and wherein the pipe parts, in the slid-together state, can be twisted in the tangential direction to make the lugs of the first pipe part engage on the lugs of the second pipe part for fixing of the pipe parts in the axial direction.

By virtue of a suitable size and placement of the lugs (herein also referred to as teeth or projections), space can be present between the lugs of one pipe part (for example an inner socket) in order to allow the lugs of the other pipe part (for example an outer socket) to pass. By then twisting one pipe part over a certain length (for example one lug length) to the right or left and axially displacing it, it is possible to bring the second row (and possibly more rows) into engagement.

In this state, in which the lugs of the first pipe part engage on the lugs of the second pipe part, the lugs of one pipe part are preferably all (or, at least, a large part of them) located opposite the lugs of the other. In the case of two rows of lugs, the full circumferences of the pipe parts, or a large portion thereof, are then eventually in mutual engagement via the lugs provided thereon. This makes the coupling in the axial direction very strong, without the need to make the coupling extra heavy. In this way, a light and slender coupling is able to be obtained. If more than two rows are used, the pipe parts can be coupled to one another over more than the full circumference, which can make the structure yet more resistant to axial forces.

In one embodiment of the invention, the lugs of successive rows are arranged in the axial direction substantially in the line with one another. That is to say that the lugs of all successive lugs (or, at least, a number thereof) are not offset. If the lug teeth are not offset, merely an axial movement is sufficient to bring the two or more lug rows into position, whereafter a short twist to the left or right can fix the pipe parts in the axial direction and the coupling is realized. In a further embodiment, the pipe parts are consequently arranged such that, essentially with just an axial mutual displacement of the pipe parts, the pipe parts can be slid wholly in and out of one another, and/or, essentially with just a simple mutual twisting of the pipe parts over substantially one lug length, the lugs of the different rows can be made to engage on one another for coupling of the pipe parts and these lugs can be kept free from one another for decoupling of the pipe parts.

In other embodiments, the lugs of successive rows are offset in relation to one another in the tangential direction. In this embodiment, “intermediate steps” must be taken (rotation and further sliding in the axial direction) in order to arrive at a maximal engagement of the lugs of one pipe part on the lugs of the other pipe part. A drawback of these embodiments is that they are generally less easy to couple. An advantage is, of course, that they are also less easy to decouple. Furthermore, the axial forces are better distributed over the circumference of the pipe parts, which can benefit the structural strength of the coupling.

In a further embodiment, along the circumference of each pipe part a first row of lugs and at an axially displaced position a second row of lugs are provided, wherein each of the rows of lugs is designed to form alternately in the axial direction penetrable and impenetrable regions, and wherein the penetrable and impenetrable regions of the first row are provided at circumferentially displaced positions in relation to the positions of the regions of the second row; and wherein the lugs of the first and second pipe part are provided in such a way on respectively the outer circumference and inner circumference of the associated pipe part that the pipe parts can be slid one into the other.

It has been found that the strength of the known bayonet coupling is limited partly by the fact that, at the site of the penetrable regions, no transmission of the forces applied to the pipes, and thus also to the coupling, can take place. In the known types of bayonet couplings, these penetrable regions are additionally present along the greatest part of the coupling length in the circumferential direction (herein also referred to as the coupling circumference). This means that only a small part of the total circumference of the coupling can be used for the transmission of forces, and so the load on this part becomes large. The invention provides for the enlargement of the coupling length. The result is a coupling between two successive pipes, which coupling provides a good transmission of the axial forces arising on the pipes, since, over almost half of the circumference, coupling surfaces are present to absorb the forces.

A further advantage of the coupling is that both the coupling and decoupling of the pipes remains relatively simple. Coupling is realized by sliding the coupling parts into one another and decoupling is realized by sliding the coupling parts out of one another. Moreover, no moving parts need to be present in the coupling (though in certain embodiments the choice can be made to still construct the coupling with moving parts, for example for locking the coupling). A further advantage is that the coupling can be operated by displacement (for example in the axial direction and/or tangential direction) of the pipes on which the couplings are provided. In addition, the inner side of the pipe assembly can be made relatively smooth, which reduces the wear on the pipes, for example if it is a question of a downpipe along which relatively hard material, such as stone, is poured downwards.

In further embodiments, a coupling can be realized by first making a “crude” confinement by allowing the lugs of one lug to pass the first row (or a first set of rows), in which the penetrable regions of the other lug are relatively large and therefore the lugs of one lug can pass these regions relatively easily. After this, a second row (or set of rows) is passed, in which the penetrable regions have a narrower dimensional tolerance in relation to the lugs.

According to a further embodiment, the axial distance between the first and second row of lugs of a coupling is greater than the axial thickness of the lugs in order to procure a rotation space in which the lugs can be twisted in relation to one another.

In a further embodiment, the lugs comprise a number of lugs evenly distributed over the circumference of the tubular connecting element. Although such lugs are not evenly distributed over the circumference in all embodiments, the advantage of this embodiment is that, in a relatively large number of rotational positions, the lugs are arranged in relation to one another such that they can be slid through the penetrable regions. If the lugs are unevenly distributed over the circumference, it may sometimes be necessary to rotate the pipe parts precisely into one specific position in relation to one another to enable the lugs to be slid in. This can be advantageous if the pipe parts must be coupled in a specific position in relation to one another.

In further embodiments, the length in the circumferential direction of a lug forming an impenetrable region substantially conforms to the length in the circumferential direction of a space therebetween forming a penetrable region, so that the lug is able to pass through the penetrable region, yet a maximum possible contact surface for the transmission of forces is maintained when the lugs are twisted over one lug length. In other embodiments, the said length of the lug can be far smaller than the said space, so that the lug can pass through the space more comfortably.

According to one embodiment, the coupling comprises a locking element having at least one projection, which projection, in the coupled state, can be placed between the lugs of successive rows. A locking element of this type can be provided to block the mutual rotational movement of the pipe parts and thus maintain the state in which the pipe parts are fixed in relation to one another in the axial direction. This prevents the coupling from being possibly decoupled by unhoped-for twisting of a connecting element. More specifically, in certain embodiments in the coupled state empty spaces are present between the lugs of the first row of a first connecting element and the lugs of the second row of an opposite-situated, second connecting element. Such a projection can be placed in one or more of these spaces, so that the coupling can no longer be decoupled. In particular, the locking element comprises a locking ring, which can be slipped around one of the sockets. The locking ring can then be provided with one or more projections, which are designed and arranged such that they can be slid into one or more corresponding spaces.

In certain embodiments, for example when the pipe assembly is used to transport material from and to a bottom (sea bed), the pipes and couplings are made of steel or other material so as to be able to absorb the forces which arise. In other embodiments, the pipes can be made of composite material. The couplings themselves can consequently be made of composite material or of steel. Otherwise, the lugs can be separate parts which are fastened to a pipe or can be formed integrally with the pipe.

Further advantages, characteristics and details of the present invention will be clarified with the aid of the following description of some embodiments thereof. In the description, reference is made to the appended drawings, in which:

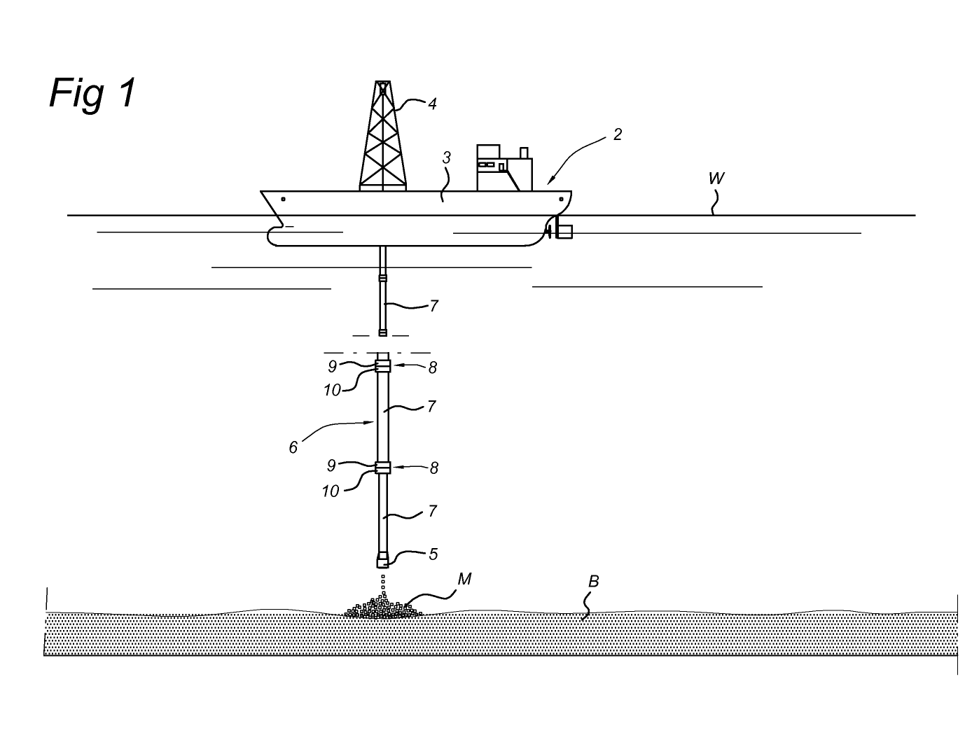

FIG. 1 shows a view of a vessel provided with a downpipe, the individual pipes of which are coupled to one another by an embodiment of the invention;

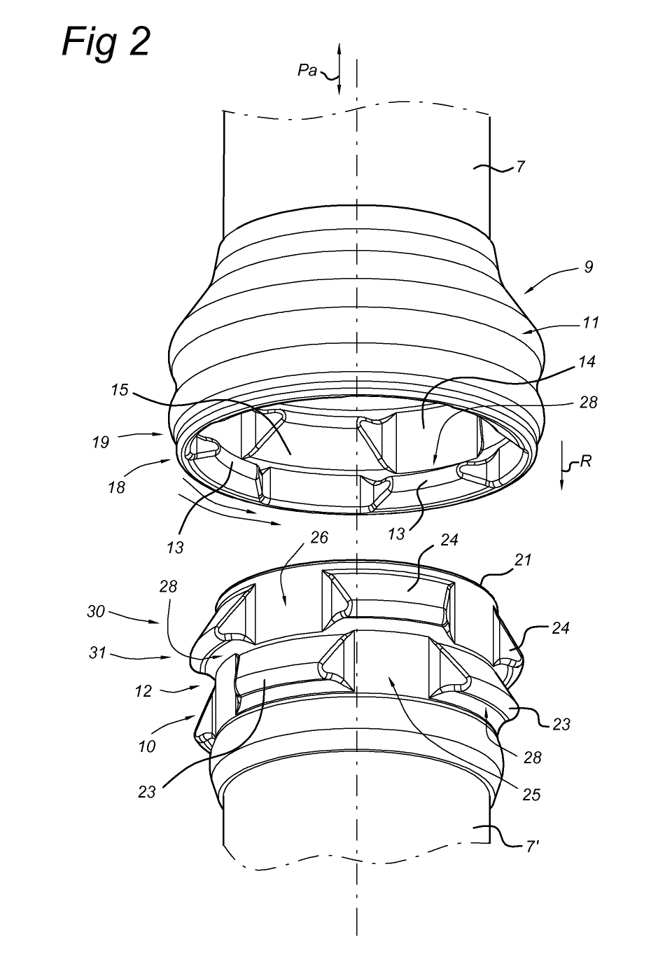

FIG. 2 shows a perspective view of the first embodiment of such a coupling;

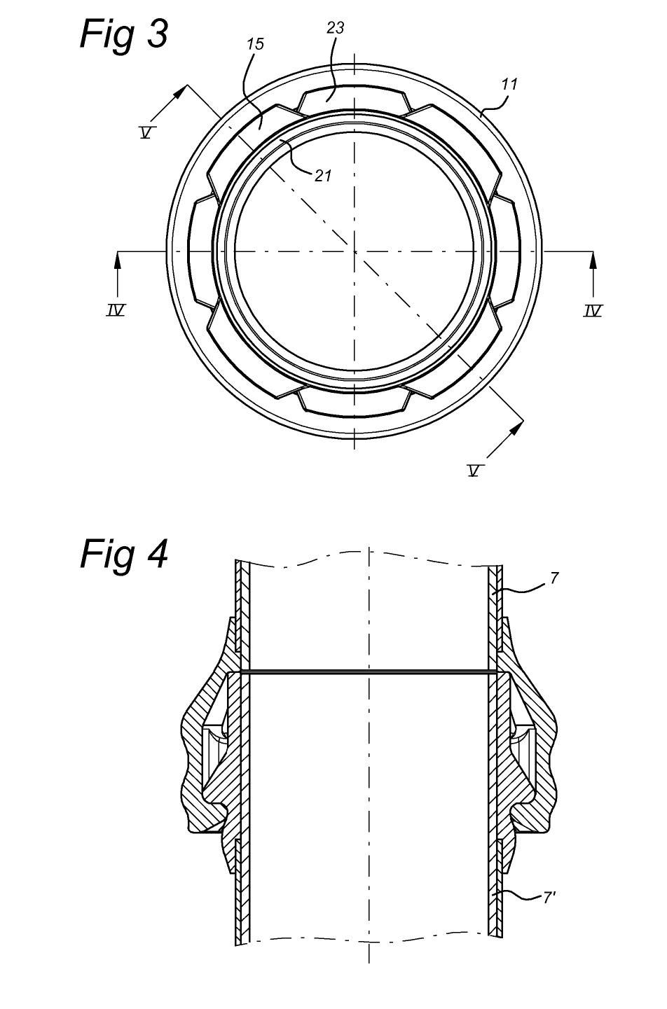

FIG. 3 shows a cross section of the embodiment of FIG. 2;

FIG. 4 shows a longitudinal cross section along the line IV-IV of FIG. 3;

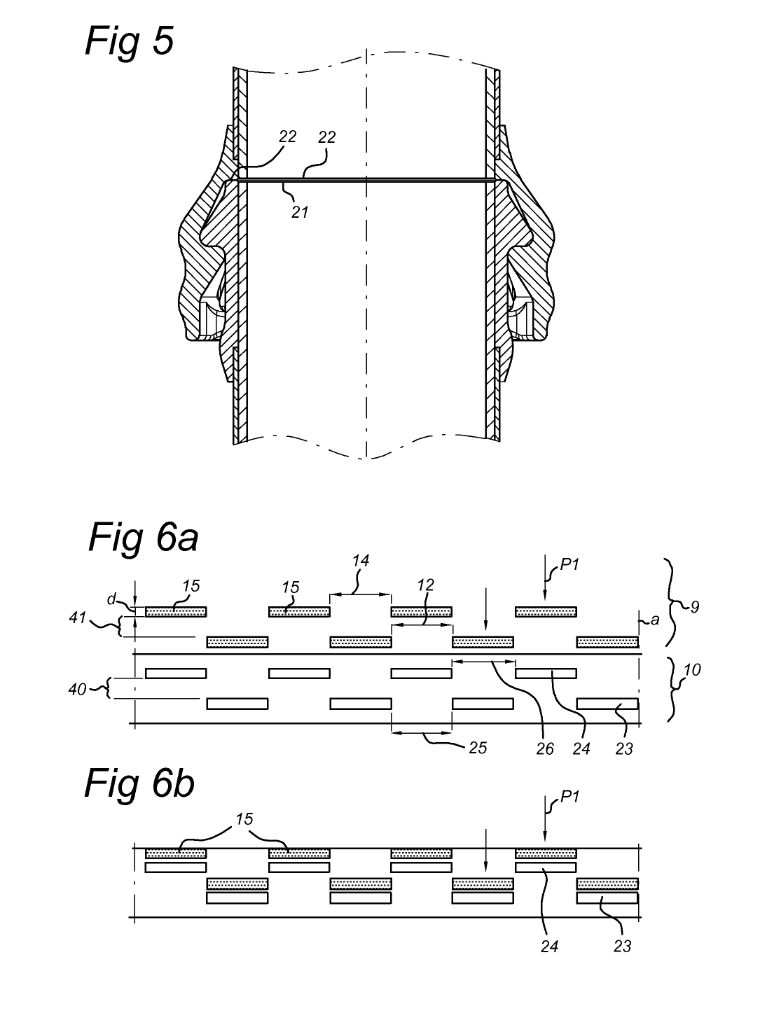

FIG. 5 shows a longitudinal cross section along the line V-V of FIG. 3;

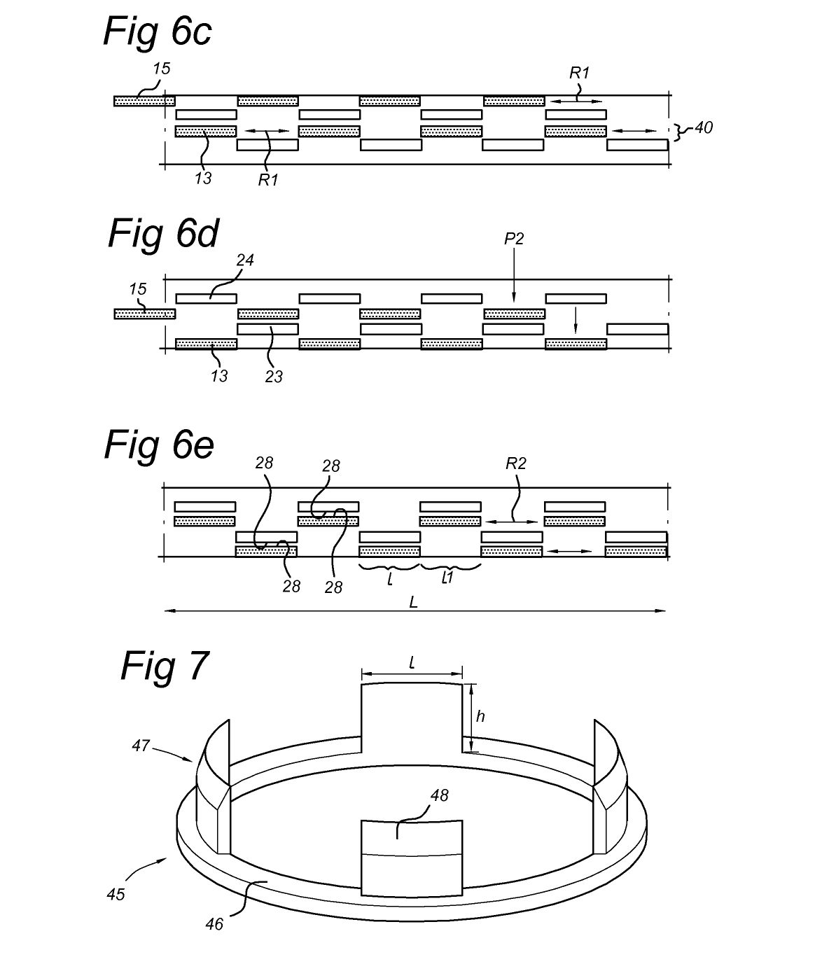

FIGS. 6a-6e show schematic representations of the first embodiment according to the invention in different stages of the coupling activity; and

FIG. 7 shows a perspective view of an embodiment of a locking element according to the invention,

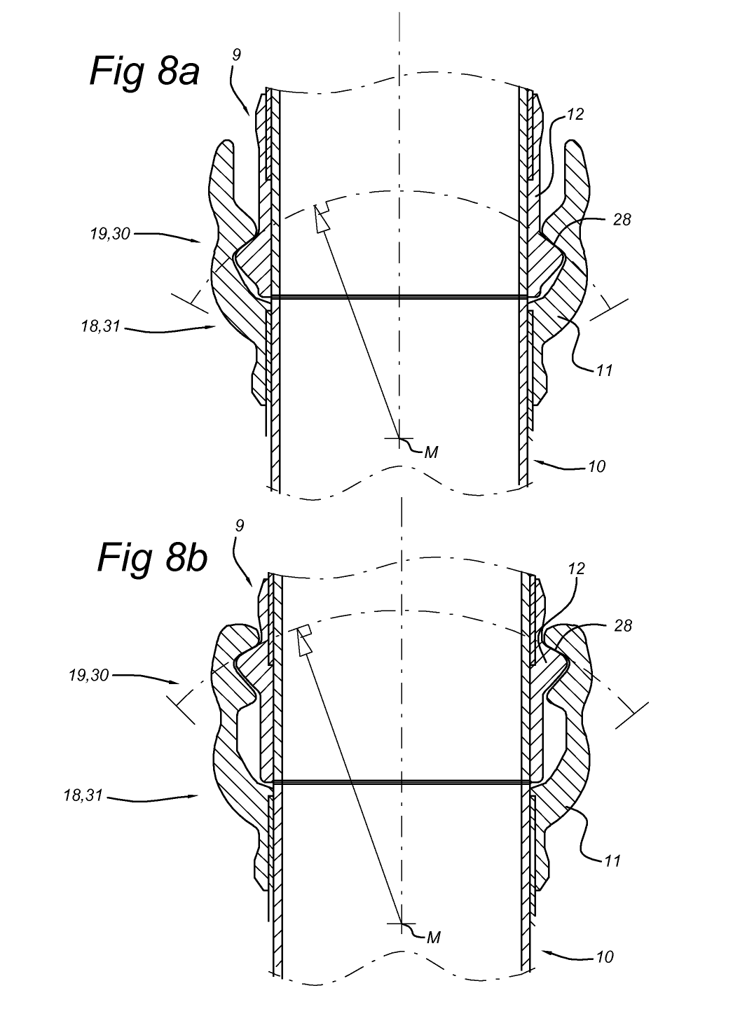

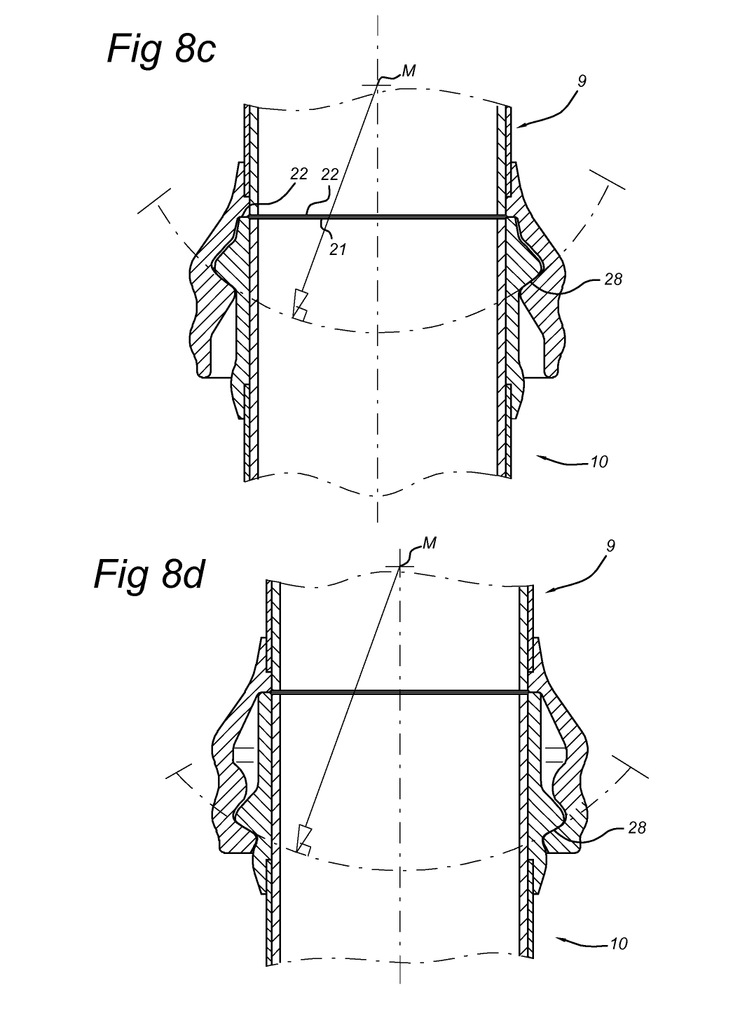

FIGS. 8a-d and 9 show cross sections of further embodiments.

As herein described, the invention relates to the releasable coupling of pipes or pipe parts (herein referred to, in short, as pipe parts). The term “pipe parts” should here be interpreted broadly. For example, the pipe parts can be of a relatively inflexible variety or can even be of rigid construction, such as steel pipes, but flexible pipes may also be used. By the term “flexible” pipes should be understood hoses, pipelines, pipes or tubes, ducts and the like, which are made to be flexible to a greater or lesser degree.

FIG. 1 shows a vessel 2, which in customary manner is made up of an elongated hull 3 on which an installation 4 is placed. The installation 4 is arranged to hold a downpipe assembly 6 in place. The downpipe assembly 6 comprises a number of pipes 7 positioned one behind the other, which are coupled together with the aid of couplings 8. The bottommost downpipe is provided with a mouth 5 (represented purely schematically), via which material M can be poured onto a bottom B. The material M originates from the hold of the vessel 2 and has been introduced in a known manner via a fill opening on the top side of the downpipe assembly. The material M can be planted on the bottom for a variety of reasons, for example in order to cover a conveyor pipeline placed on the bottom. In other embodiments, the pipe assembly can be formed, for example, by the suction pipe of a trailing suction hopper dredger.

In order to simplify the drawing, only a limited number of pipes 7 is represented. The pipe assembly is suitable for deep-sea applications.

The couplings 8 with which the pipes 7 placed one behind the other are connected to one another respectively comprise a first pipe part 9 fitted to a first pipe (for example an upper pipe 7) and a second pipe part 10 fitted to a second pipe 7′. Other embodiments are also possible of course, for example embodiments in which there are pipes which are only provided with first pipe parts 9 and other pipes which are only provided with second pipe parts 10.

Referring to FIGS. 2 to 5, an embodiment of the coupling 8 is described in more detail. FIG. 2 shows a first pipe part 9 comprising a substantially cylindrical outer socket 11. In the shown embodiment, the socket 11 is somewhat widened in relation to the end of the pipe 7 so as to be able to receive within it the opposite-situated pipe part 10, which latter shall be described in greater detail later. On the inner side of the socket 11, two rows of lugs are provided. A first row 18, which is made up of lugs 13 evenly distributed over the inner circumference of the socket 11, is represented. In addition, a second row 19 of lugs, consisting of lugs 15 distributed over the inner circumference of the socket 11, is represented. The two rows 18, 19 are positioned at a predefined axial distance apart (the axial direction Pₐ being represented in FIG. 2).

The second pipe part 10 similarly comprises a substantially cylindrical socket 12. The socket 12 is provided on the outer side with two rows 30, 31 of lugs in the form of lugs 24 and lugs 23 respectively. The first row 30 of lugs 24, just like the first row 18 of the first pipe part 9, is provided along the circumference of the socket 12, the row extending substantially transversely to the axial direction.

The lugs 13, 15 of the first pipe part 9 and the lugs 23, 24 of the second pipe part 10 all extend substantially transversely in relation to the axial direction. Between the lugs, respective penetrable regions 26, 25 are formed in respectively the first row 30 and second row 31 of the second pipe part 10, and penetrable regions 12, 14 in respectively the first row 18 and second row 19 of the first pipe part 9. The respective lugs 24, 23 in the first and second row 30, 31 and lugs 13, 15 in the first and second row 18, 19 form so-called impenetrable regions. An impenetrable region is a region in which, as a result of the presence of a lug, there is no room to slide the socket 11, 12 inwards. The axially inward sliding of one socket into the other can only be realized by positioning the lugs of the first row 30 of the second pipe part 10 in front of the penetrable regions 12 between the lugs 13 of the first row 18 of the first pipe part 9. This is represented in more detail in FIGS. 6a-6e.

Furthermore, the successive rows 18, 19 and rows 30, 31 are each arranged at a mutual distance apart, for example at a fixed distance (a). This distance (a) is greater than the thickness (d) of the lugs, which ensures that between rows 30 and 31 a rotation space 40 and between successive rows 18, 19 a rotation space 41 is created. These rotation spaces 40, 41 extend in the circumferential direction (transversely to the axial direction) and offer the possibility of twisting the lugs therein.

In use, one of the lugs, in the represented situation the upper pipe part 9, is displaced downwards from above (direction P₁), so that the lugs 13 of the first row 18 of the socket 11 are slid via the penetrable openings 26 between neighbouring lugs 24 of the first row 30 of the socket 10 so as to end up in the first rotation space 40. This situation is represented in FIG. 6b. In the position represented in FIG. 6b, the lugs 13 of the first row of the upper pipe part 9, and thus likewise the lugs 15 of the second row 19 of lugs 15, are slid through to the point where they rest against the corresponding lugs of the second and first row 31, 30 respectively. Further axial displacement of the lug is therefore not possible.

After this, the first pipe part 9 is twisted somewhat (direction R₁) into the position represented in FIG. 6c. The twisting of the first pipe part 9, and thus also of the lugs 13, 15 thereof, is possible, because the lugs 13 are freely rotatable in the aforementioned rotation space 40 between the first row 30 and second row 31. Once the lugs have ended up in the position represented in FIG. 6c, that is to say when the lugs 13 have been twisted in the rotation space 40 such that they are located opposite penetrable regions 25 of the second row 31 of the second pipe part 10, the first pipe part 9 can be displaced further in the axial direction (P₂) to the position represented in FIG. 6d. The second row 19 of lugs 15 can also now be twisted in the rotation space 40, for example in the same rotational direction as previously adopted (though an opposite rotational direction is also possible). The lugs 9, 10 are now twisted in such a way in relation to one another (rotational direction R₂) until the lugs 13 of the first row 18 of the first pipe part 9 lie directly below the corresponding lugs 23 of the second row 31 of the second pipe part 10. This situation is represented in FIG. 6e.

In the end position represented in FIG. 6e, each of the contact surfaces 28 of a lug 13, 15, 23, 24 has been brought into contact with an opposite-situated contact surface of another lug. As is clearly represented in FIG. 6e, the summation of the lengths (1,1′) of the combined surface over which two neighbouring lugs make contact with one another with their contact surface 28 is equal to L. This combined length L over which the lugs are in contact with one another largely determines the force transmissibility of the coupling. In the represented embodiment, the combined length L is almost equal to the total circumference of the socket 11, 12, which means that virtually the whole of the coupling circumference is used in a force-transmitting manner. Since the pipe coupling offers a force transmission over substantially the whole of the circumference, the specific force transmission per lug is better than in conventional couplings and the coupling is better resistant to the, in relative terms, very large loads which can arise on such a coupling.

The decoupling of the coupling is realized by performing the above-described actions in the reverse order. It should here be noted that, since in the coupling process it does not matter in which direction (R₁), i.e. to the left or right, a lug is rotated in relation to the other lug, this is likewise not the case in the decoupling process. In the decoupling, the lugs can therefore also be rotated in the same direction as in the coupling.

In FIG. 7 is represented an embodiment of a locking element 45 with which the coupling can be secured. To this end, the locking element 45 comprises an annular part or element 46, the inner circumference of which is chosen such that it can be slipped around the tubular socket 12. On one side, the annular element 46 is provided with one or more upright lugs 47. In the embodiment represented in FIG. 7, four lugs 47 are provided, which are each dimensioned such that they can be slid into the interspaces 14 between the lugs of the first row of the pipe part. In order to simplify the insertion of the lugs 42 of the locking element 45, the ends thereof are preferably provided with bevelled locating edges 48. The width (b) of the lugs 47 should be smaller than or almost equal to the width of the said interspaces 14. Preferably, the width (b) is almost as large as the said interspace, so that the pipe parts 9, 10 can slide only to a limited extent in relation to one another once the lugs 47 of the locking element have been slid into the interspaces. The height (h) of the lugs 47 of the locking element 45 can vary, but should at least be of such magnitude that the lugs 23 of the second row 31 of the second pipe part 10 and the lugs 13 of the first row 18 of the first pipe part 9 cannot or can scarcely any longer be twisted in relation to one another.

When the locking element 45 is brought into the situation represented in FIG. 2 by slipping it upwards over the tubular element 12, the locking element 45 must still be fastened in some way to prevent it from sliding down under the influence of gravity.

This can be done, for example, by clamping the annular element 46 onto a bottom edge of the tubular element 12. In other embodiments, in which the first pipe part 9 is located below the second pipe part 10, the locking element 45 rests on the topmost pipe part and the locking element 45 shall remain held in the locked position under the influence of gravity. In such a situation, the fastening of the locking element 45 to the coupling can possibly be dispensed with.

In the embodiment of the locking element 45 which is represented in FIG. 7, the number of lugs is equal to the number of interspaces between the lugs of the pipe part in question. The number of lugs 47 on the locking element 45 can also, however, be smaller. In fact, the insertion of one single lug is sufficient to make the pipe parts 9, 10 untwistable or, at least, rotatable in insufficient measure.

### Further Embodiments

The couplings as described above with reference to FIGS. 1 to 7 inclusive can have the disadvantage that, in the event of a lateral load substantially transversely to the axial direction of the pipes 7, for example as a result of current, the load is no longer evenly distributed over the different lugs. As a result of such a lateral load, the coupled pipes 7 can move in relation to one another in the sense that they tend to begin standing at an angle to one another. The axial body axis of one pipe 7 is then no longer parallel to the axial body axis of the pipe 7 coupled thereto.

As a result thereof, the axial load is no longer evenly distributed over the different lugs, but the load will increase along a first circumferential part of the pipe parts and decrease along a second circumferential part. The effective coupling length of the lugs is thus diminished. This effect reduces the strength of the coupling and causes extra wear along the first circumferential part.

A secondary adverse effect is that, under the influence of a varying lateral load, the pipes 7 can rotate in relation to one another. This is explained in greater detail below.

Under the influence of lateral load, two coupled-together pipes 7 can proceed to stand at an angle to one another. The two axial body axes of the two pipes 7 are then no longer parallel, but stand at a small angle a to one another (for example α≈1-3°. The direction of the lateral load can vary, as a result of which the angle a rotates, for example, to the left or right. It is also possible that, as a result of the wave motions of the water and resulting movement of the ship, the coupled pipes 7 proceed to move in relation to one another. Running waves can thus occur in the coupled pipes 7. The fact that the pipes 7 have mutually acquired a certain degree of freedom of movement prevents the herein arising forces from rising too high. As a result of this, the pipes 7 can proceed to move tangentially in relation to one another, that is to say proceed to rotate around the body axes, which can result in a diminished coupling or even an unwanted uncoupling.

The object of the here described embodiment is to eliminate or, at least, lessen these disadvantages.

FIGS. 8a-8b show such an embodiment, in which a coupling for the releasable coupling of pipe parts is shown, the coupling comprising:
a first pipe part, which on the outer circumference has two or more rows of lugs;
a second pipe part, which on the inner circumference has two or more rows of lugs;
   wherein the lugs of each of the rows of the first pipe part and of the second pipe part have interspaces which are designed to allow lugs of one pipe part to pass the lugs of the other pipe part for sliding of the pipe parts into and out of one another in the axial direction, and wherein the pipe parts, in the slid-together state, can be twisted in the tangential direction to make the lugs of the first pipe part engage on the lugs of the second pipe part for fixing of the pipe parts in the axial direction, wherein the lugs are provided with contact surfaces 28, which, following coupling, bear against corresponding contact surfaces 28 of the other pipe part, wherein the contact surfaces 28 are formed as part of a spherical surface, and wherein the centre points M for all contact surfaces 28, which centre points are associated with the spherical surfaces, substantially coincide on an axial body axis of the respective first and second pipe part.

The pipe parts can have a typical diameter of, for example, 250-2000 mm, for example 732 mm. The contact surfaces 28 can be formed as part of a spherical surface, wherein the sphere associated therewith can have a radius of, for example, 0.5 to 2.5 times the diameter of the pipe parts. It is here noted that, because the centre points M for the contact surfaces 28 of the different rows of lugs coincide, the different rows have a different radius. Thus, in a pipe part of 732 mm diameter, the radius of the first row of lugs can be equal to 654 mm and that of the second row of lugs be equal to 813 mm.

The embodiments shown in FIGS. 8a-8d can be used in combination with all the embodiments which have been shown and described above.

FIGS. 8a and 8b show an embodiment wherein the lugs of successive rows are tangentially offset in relation to one another (analogously to FIGS. 2-6).

The lugs of the second pipe part 10 comprising a substantially cylindrical outer socket 11 are provided on the inner side of the socket 11 and comprise contact surfaces 28 of concave design. Because the centre points M for all contact surfaces 28 of all rows of lugs, which centre points are associated with the spherical surfaces, substantially coincide, it is clear that the contact surfaces 28 of the lugs 13 of the first row 18 (see FIG. 8a) are more strongly curved than the contact surfaces 28 of the lugs 15 of the second row 19 (see FIG. 8b).

The lugs of the first pipe part 9 comprising a substantially cylindrical socket 12 are provided on the outer side of the socket 12 and comprise contact surfaces 28 of convex design. Because the centre points M for all contact surfaces 28 of all rows of lugs, which centre points are associated with the spherical surfaces, substantially coincide, it is clear that the contact surfaces 28 of the lugs 24 of the first row 30 are less strongly curved than the contact surfaces 28 of the lugs 15 of the second row 19.

The centre points M for all contact surfaces 28, which centre points are associated with the spherical surfaces, substantially coincide on an axial body axis of the respective first and second pipe part. This point is indicated in FIGS. 8a and 8b with reference M. The centre points M thus lie on a substantially same spot in both FIGS. 8a and 8b.

FIGS. 8c and 8d show a variant wherein the lugs of the second pipe part 10 comprising a substantially cylindrical socket are provided on the outer side of the socket and comprise contact surfaces 28 of convex design. The lugs of the first pipe part 9 comprising a substantially cylindrical outer socket are provided on the inner side of the socket and comprise contact surfaces 28 of concave design.

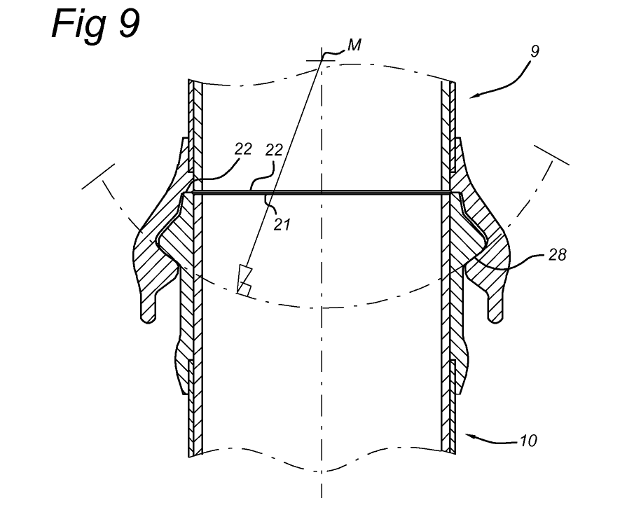

FIG. 9 further shows a coupling for the releasable coupling of pipe parts, the coupling comprising:
a first pipe part, which on the outer circumference has one or more rows of lugs;
a second pipe part, which on the inner circumference has one or more rows of lugs;
   wherein the lugs of each of the rows of the first pipe part and of the second pipe part have interspaces which are designed to allow lugs of one pipe part to pass the lugs of the other pipe part for sliding of the pipe parts in and out of one another in the axial direction, and wherein the pipe parts, in the slid-together state, can be twisted in the tangential direction to make the lugs of the first pipe part engage on the lugs of the second pipe part for fixing of the pipe parts in the axial direction, wherein the lugs are provided with contact surfaces 28, which, following coupling, bear against corresponding contact surfaces 28 of the other pipe part, wherein the contact surfaces 28 are formed as part of a spherical surface, and wherein the centre points for all contact surfaces 28, which centre points are associated with the spherical surfaces, substantially coincide on an axial body axis of the respective first and second pipe part.

Of course, the embodiment shown in FIG. 9 can also be made in different variants. FIG. 9 now shows that the bottommost pipe part comprises a substantially cylindrical socket, with lugs on the outer side of the socket, and contact surfaces 28 of convex design. The lugs of the topmost pipe part comprising a substantially cylindrical outer socket are provided on the inner side of the socket and comprise contact surfaces 28 of concave design.

However, this can also be realized the other way round, analogously to FIGS. 8a and 8b, in which the upper pipe part comprises a substantially cylindrical socket, with lugs on the outer side of the socket, and contact surfaces 28 of convex design. The lugs of the lower pipe part comprising a substantially cylindrical outer socket are provided on the inner side of the socket and comprise contact surfaces 28 of concave design.

The embodiments shown in FIGS. 8a-d and 9 have the advantage that, in the event of a lateral load, the pipe parts can rotate in relation to one another around the centre points M, whilst all lugs remain in contact with the corresponding lugs of the other pipe part. The effective coupling length thus remains at a maximum.

The shown and discussed embodiments relate to pipe parts which are suspended one from another, wherein pipe parts hang from a pipe part located directly above them. Of course, the highest pipe part hangs from a vessel, for example. Naturally, embodiments in which the pipes are stacked, that is to say that the pipe parts lean on a pipe part located directly below them, are also possible. The bottommost pipe part can rest on the bottom.

The present invention is not limited to those embodiments thereof which are herein described. The described coupling can be used in a number of fields outside the described maritime examples. The applied-for rights are rather defined by the following claims, within whose scope a variety of applications and modifications are conceivable.

1.-27. (canceled)

28. A coupling for the releasable coupling of pipe parts, the coupling comprising:
a first pipe part, which on the outer circumference has two or more rows of lugs;
a second pipe part, which on the inner circumference has two or more rows of lugs;
wherein the lugs of each of the rows of the first pipe part and of the second pipe part have interspaces which are designed to allow lugs of one pipe part to pass the lugs of the other pipe part for sliding of the pipe parts into and out of one another in the axial direction; and
wherein the pipe parts, in the slid-together state, can be twisted in the tangential direction to make the lugs of the first pipe part engage on the lugs of the second pipe part for fixing of the pipe parts in the axial direction;
wherein along the circumference of each pipe part a first row of lugs and at an axially displaced position a second row of lugs are provided;
wherein each of the rows of lugs is designed to form alternately in the axial direction penetrable and impenetrable regions, and wherein the penetrable and impenetrable regions of the first row are provided at circumferentially displaced positions in relation to the positions of the regions of the second row; and
wherein the lugs of the first and second pipe part are provided in such a way on respectively the outer circumference and inner circumference of the associated pipe part that the pipe parts can be slid one into the other.

29. The coupling according to claim 28, wherein the lugs of successive rows are offset in relation to one another in the tangential direction.

30. The coupling according to claim 29, wherein the pipe parts are arranged to slide the pipe parts, with alternate axial sliding and tangential rotation of one of the two pipe parts, fully into or out of one another.

31. The coupling according to claim 30, wherein the pipe parts are arranged to engage, in the wholly slid-in position, with a single mutual twisting of the pipe parts over substantially one lug length, the offset lugs of the different rows on one another for fixing of the pipe parts.

32. The coupling according to claim 28, wherein, in fully slid-in and twisted position, all lugs of the first pipe part are located opposite corresponding lugs of the second pipe part.

33. The coupling according to claim 28, wherein the combined coupling length in the circumferential direction of the mutually engaging lugs amounts to at least half of the total circumferential length of the first or second pipe part, preferably is at least as great as the circumferential length of one pipe part, still more preferably is greater than the circumferential length of the tubular connecting element in question.

34. The coupling according to claim 28, wherein the pipe parts, in the coupled state, are arranged to be mutually coupled with a force transmission along more than half of the pipe part circumference.

35. The coupling according to claim 28, wherein the lugs, from the slid-out state, are arranged to
slide the lugs of the first row of lugs of one lug in the axial direction through the penetrable regions of the first row of the other lug,
twist the lugs in relation to one another until the lugs of the first row of lugs of one lug are positioned opposite the impenetrable regions of the second row of the other lug,
slide the lugs of the first row of lugs of one lug in the axial direction through the penetrable regions of the second row of the other lug and, at the same time, the lugs of the second row of lugs of the one lug in the axial direction through the penetrable regions of the first row of the other lug, and
twist the lugs in relation to one another until the lugs of the first and second row of lugs of the one lug are situated opposite corresponding lugs of respectively the first and second row of lugs of the other lug.

36. The coupling according to claim 28, wherein the lugs, from the coupled state, are arranged to
twist the lugs in relation to one another until the lugs of the first and second row of lugs of the one lug are situated opposite the corresponding penetrable regions of the other lug,
slide the lugs of the first row of lugs of one lug back in the axial direction through the penetrable regions of the second row of the other lug and slide the lugs of the second row of lugs of the one lug back in the axial direction through the penetrable regions of the first row of the other lug,
twist the lugs in relation to one another until the lugs of the first row of lugs of the one lug are positioned opposite the penetrable parts of the second row of the other lug, and
slide the lugs of the first row of lugs of the one lug back in the axial direction through the penetrable regions of parts of the first row of the other lug.

37. The coupling according to claim 28, wherein the axial distance between successive rows of lugs is greater than the axial thickness of the lugs in order to procure a rotation space in which the lugs can be twisted in relation to one another.

38. The coupling according to claim 28, comprising a locking element having at least one projection that in coupled state can be placed between the lugs of successive rows.

39. The coupling according to claim 28, wherein a pipe part is fixedly fastened to a pipe or constitutes a part of a pipe.

40. The coupling according to claim 28, wherein the lugs are provided with contact surfaces (28), which, following coupling, bear against corresponding contact surfaces (28) of the other pipe part, wherein the contact surfaces (28) are formed as part of a spherical surface, and wherein the centre points M for all contact surfaces (28), which centre points are associated with the spherical surfaces, substantially coincide on an axial body axis of the respective first and second pipe part.

41. An assembly of pipes comprising:
at least one coupling including
a first pipe part, which on the outer circumference has two or more rows of lugs,
a second pipe part, which on the inner circumference has two or more rows of lugs,
wherein the lugs of each of the rows of the first pipe part and of the second pipe part have interspaces which are designed to allow lugs of one pipe part to pass the lugs of the other pipe part for sliding of the pipe parts into and out of one another in the axial direction, and
wherein the pipe parts, in the slid-together state, can be twisted in the tangential direction to make the lugs of the first pipe part engage on the lugs of the second pipe part for fixing of the pipe parts in the axial direction,
wherein along the circumference of each pipe part a first row of lugs and at an axially displaced position a second row of lugs are provided,
wherein each of the rows of lugs is designed to form alternately in the axial direction penetrable and impenetrable regions, and wherein the penetrable and impenetrable regions of the first row are provided at circumferentially displaced positions in relation to the positions of the regions of the second row, and
wherein the lugs of the first and second pipe part are provided in such a way on respectively the outer circumference and inner circumference of the associated pipe part that the pipe parts can be slid one into the other; and
wherein the pipes in the coupled state form an elongated pipe assembly, or the pipes in the coupled state form an elongated pipe assembly for the removal of material or the planting of material, or the pipes in the coupled state form an elongated pipe assembly for the removal of material from or the planting of material on a water bottom.

42. A vessel comprising:
a number of releasably coupled pipes that form one or more elongated pipe assemblies for the removal of material from or the planting of material on a water bottom, arranged one behind the other, for directing the material along them in the direction of the water bottom, wherein neighbouring pipes are coupled with a coupling including
a first pipe part, which on the outer circumference has two or more rows of lugs,
a second pipe part, which on the inner circumference has two or more rows of lugs,
wherein the lugs of each of the rows of the first pipe part and of the second pipe part have interspaces which are designed to allow lugs of one pipe part to pass the lugs of the other pipe part for sliding of the pipe parts into and out of one another in the axial direction, and
wherein the pipe parts, in the slid-together state, can be twisted in the tangential direction to make the lugs of the first pipe part engage on the lugs of the second pipe part for fixing of the pipe parts in the axial direction,
wherein along the circumference of each pipe part a first row of lugs and at an axially displaced position a second row of lugs are provided,
wherein each of the rows of lugs is designed to form alternately in the axial direction penetrable and impenetrable regions, and wherein the penetrable and impenetrable regions of the first row are provided at circumferentially displaced positions in relation to the positions of the regions of the second row, and
wherein the lugs of the first and second pipe part are provided in such a way on respectively the outer circumference and inner circumference of the associated pipe part that the pipe parts can be slid one into the other.
